(19) United States
(12) Patent Application Publication
(10) Pub. No.: US 2010/0036700 A1
(43) Pub. Date: Feb. 11, 2010

(54) AUTOMATICALLY PRESCRIBING TOTAL BUDGET FOR MARKETING AND SALES RESOURCES AND ALLOCATION ACROSS SPENDING CATEGORIES

(75) Inventors: David Cavander, Los Angeles, CA (US); Wes Nichols, Los Angeles, CA (US); Jon Vein, Los Angeles, CA (US); Dominique Hanssens, Los Angeles, CA (US)

Correspondence Address: PERKINS COIE LLP;PATENT-SEA, P.O. BOX 1247, SEATTLE, WA, 98111-1247, US

(73) Assignee: MarketShare Partners LLC, Santa Monica, CA (US)

(21) Appl. No.: 12/187,326

(22) Filed: Aug. 6, 2008

(51) Int. Cl. G06F 17/30

(52) U.S. Cl. 705/8

(57) ABSTRACT

A facility for automatically prescribing, for a distinguished offering, an allocation of resources to a total marketing budget and/or individual marketing activities is described.

### TECHNICAL FIELD

The described technology is directed to the field of automated decision support tools, and, more particularly, to the field of automated budgeting tools.

### BACKGROUND

Marketing communication (“marketing”) is the process by which the sellers of a product or a service—i.e., an “offering”—educate potential purchasers about the offering. Marketing is often a major expense for sellers, and is often made of a large number of components or categories, such as a variety of different advertising media and/or outlets, as well as other marketing techniques. Despite the complexity involved in developing a marketing budget attributing a level of spending to each of a number of components, few useful automated decision support tools exists, making it common to perform this activity manually, relying on subjective conclusions, and in many cases producing disadvantageous results.

In the few cases where useful decision support tools exist, it is typically necessary for the tool's user to provide large quantities of data about past allocations of marketing resources to the subject offering, and the results that that they produced.

### BRIEF DESCRIPTION OF THE DRAWINGS

FIG. 1 is a high-level data flow diagram showing data flow within a typical arrangement of components used to provide the facility.

FIG. 2 is a block diagram showing some of the components typically incorporated in at least some of the computer systems and other devices on which the facility executes.

FIG. 3 is a table drawing showing sample contents of a library of historical marketing efforts.

FIG. 4 is a display diagram showing a sign-in page used by the facility to limit access to the facility to authorized users.

FIG. 5 is a flow diagram showing a page display generated by the facility in a view/edit mode.

FIGS. 6-9 show displays presented by the facility in order to solicit information about the subject offering for which an overall marketing budget and its distribution are to be prescribed by the facility.

FIG. 10 is a display diagram showing a result navigation display presented by the facility after collecting information about the subject offering to permit the user to select a form of analysis for reviewing results.

FIG. 11 is a display diagram showing a display presented by the facility to convey the optimal total marketing budget that the facility has is determined for the subject offering.

FIG. 12 is a display presented by the facility to show spending mix information. The display includes an overall budget prescribed by the facility.

FIG. 13 is a process diagram that describes collecting additional offering attribute information from the user.

FIG. 14 is a process diagram showing the derivation of three derived measures for the subject offering: cognition, affect, and experience.

FIG. 15 is a table diagram showing sets of marketing activity allocations, each for a different combination of the three derived attributes shown in FIG. 14.

FIG. 16 is a process diagram showing how the initial allocation specified by the table in FIG. 15 should be adjusted for a number of special conditions.

FIG. 17 is a process diagram showing how the facility determines dollar amount for spending on each marketing activity.

FIG. 18 is a process diagram showing the final adjustment to the results shown in FIG. 17.

FIG. 19 is a display diagram showing a display presented by the facility to portray resource allocation prescriptions made by the facility with respect to a number of related subject offerings, such as the same product packaged in three different forms.

### DETAILED DESCRIPTION

The inventors have recognized that, in many cases, such as in the case of a new offering, the large quantities of data about past allocations of marketing resources to the subject offering and the results that that they produced that a user would have to provide to a conventional decision support tool is not available. The inventors have further recognized that, even where such data is available, it can be inconvenient to access this data and provide it to the decision support tool.

Accordingly, a tool that automatically prescribed an advantageous allocation of funds or other resources to an offering and its various components without requiring the user to provide historical performance data for the offering would have significant utility.

A software facility that uses a qualitative description of a subject offering to automatically prescribe both (1) a total budget for marketing and sales resources for a subject offering and (2) an allocation of that total budget over multiple spending categories—also referred to as “activities”—in a manner intended to optimize a business outcome such as profit for the subject offering based on experimentally-obtained econometric data (“the facility”) is provided.

In an initialization phase, the facility considers data about historical marketing efforts for various offerings that have no necessary relationship to the marketing effort for the subject offering. The data reflects, for each such effort: (1) characteristics of the marketed offering; (2) total marketing budget; (3) allocation among marketing activities; and (4) business results. This data can be obtained in a variety of ways, such as by directly conducting marketing studies, harvesting from academic publications, etc.

The facility uses this data to create resources adapted to the facility's objectives. First, the facility calculates an average elasticity measure for total marketing budget across all of the historical marketing efforts that predicts the impact on business outcome of allocating a particular level of resources to total marketing budget. Second, the facility derives a number of adjustment factors for the average elasticity measure for total marketing budget that specify how much the average elasticity measure for total marketing budget is to be increased or decreased to reflect particular characteristics of the historical marketing efforts. Third, for the historical marketing efforts of each of a number groups of qualitatively similar offerings, the facility derives per-activity elasticity measures indicating the extent to which each marketing activity impacted business outcome for marketing efforts for the group.

The facility uses interviewing techniques to solicit a qualitative description of the subject offering from user. The facility uses portions of the solicited qualitative description to identify adjustment factors to apply to the average elasticity measure for total marketing budget. The facility uses a version of average elasticity measure for total marketing budget adjusted by the identified adjustment factors to identify an ideal total marketing budget expected to produce the highest level of profit for the subject offering, or to maximize some other objective specified by the user.

After identifying the ideal total marketing budget, the facility uses the solicited qualitative description of the subject offering to determine which of the groups of other offerings the subject offering most closely matches, and derives a set of ideal marketing activity allocations from the set of per-activity elasticity measures derived for that group.

In this manner, the facility automatically prescribes a total marketing resource allocation and distribution for the subject offering without requiring the user to provide historical performance data for the subject offering.

The sales or market response curves determined by the facility predict business outcomes as mathematical functions of various resource drivers:

Sales=F(Any Set of Driver Variables),

where F denotes a statistical function with the proper economic characteristics of diminishing returns

Further, since this relationship is based on data—either time series, cross-section, or both time series and cross-section—the method inherently yields direct, indirect, and interaction effects for the underlying conditions.

These effects describe how sales responds to changes in each of the underlying driver variables and data structures. Often, these response effects are known as “lift factors,” one proper subset of which are elasticities. As a special subset or case, these methods allow reading any on-off condition for the cross-sections or time-series.

There are various classes of statistical functions which are appropriate for determining and applying different types of lift factors. In some embodiments, the facility uses a class known as multiplicative and log log (using natural logarithms) and point estimates of the lift factors.

In certain situations, the facility uses methods that apply to categorical driver data and categorical outcomes. These include the classes of probabilistic lift factors known as multinomial logit, logit, probit, non-parametric, or hazard methods.

In various embodiments, the facility uses a variety of types of lift factors determined in a variety of ways. Statements about “elasticity” herein extend to lift factors of a variety of other types.

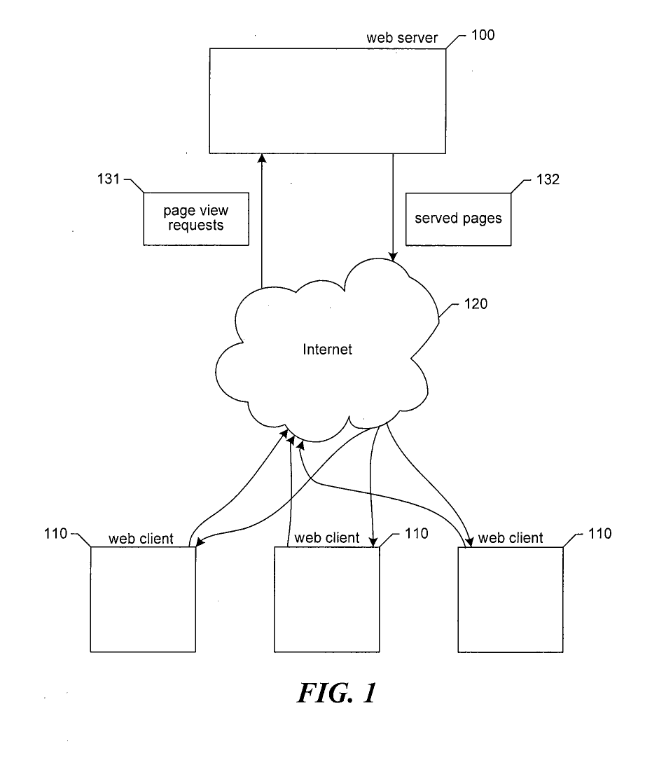

FIG. 1 is a high-level data flow diagram showing data flow within a typical arrangement of components used to provide the facility. A number of web client computer systems 110 that are under user control generate and send page view requests 131 to a logical web server 100 via a network such as the Internet 120. These requests typically include page view requests and other requests of various types relating to receiving information about a subject offering and providing information about prescribed total marketing budget and its distribution. Within the web server, these requests may either all be routed to a single web server computer system, or may be loaded-balanced among a number of web server computer systems. The web server typically replies to each with a served page 132.

While various embodiments are described in terms of the environment described above, those skilled in the art will appreciate that the facility may be implemented in a variety of other environments including a single, monolithic computer system, as well as various other combinations of computer systems or similar devices connected in various ways. In various embodiments, a variety of computing systems or other different client devices may be used in place of the web client computer systems, such as mobile phones, personal digital assistants, televisions, cameras, etc.

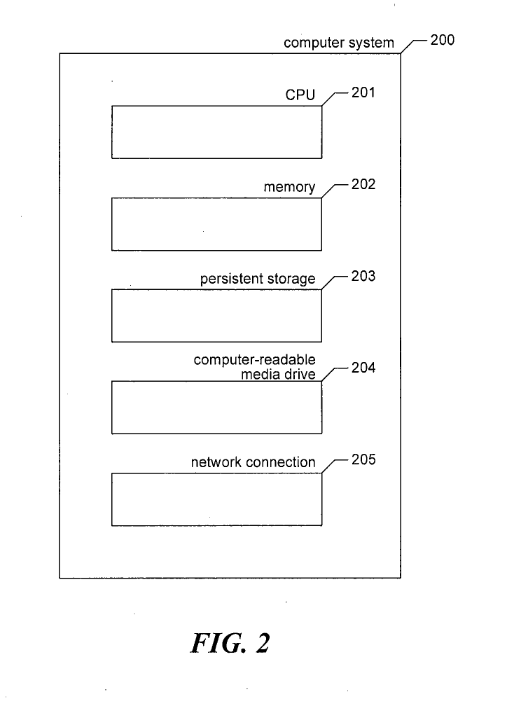

FIG. 2 is a block diagram showing some of the components typically incorporated in at least some of the computer systems and other devices on which the facility executes. These computer systems and devices 200 may include one or more central processing units (“CPUs”) 201 for executing computer programs; a computer memory 202 for storing programs and data while they are being used; a persistent storage device 203, such as a hard drive for persistently storing programs and data; a computer-readable media drive 204, such as a CD-ROM drive, for reading programs and data stored on a computer-readable medium; and a network connection 205 for connecting the computer system to other computer systems, such as via the Internet. While computer systems configured as described above are typically used to support the operation of the facility, those skilled in the art will appreciate that the facility may be implemented using devices of various types and configurations, and having various components.

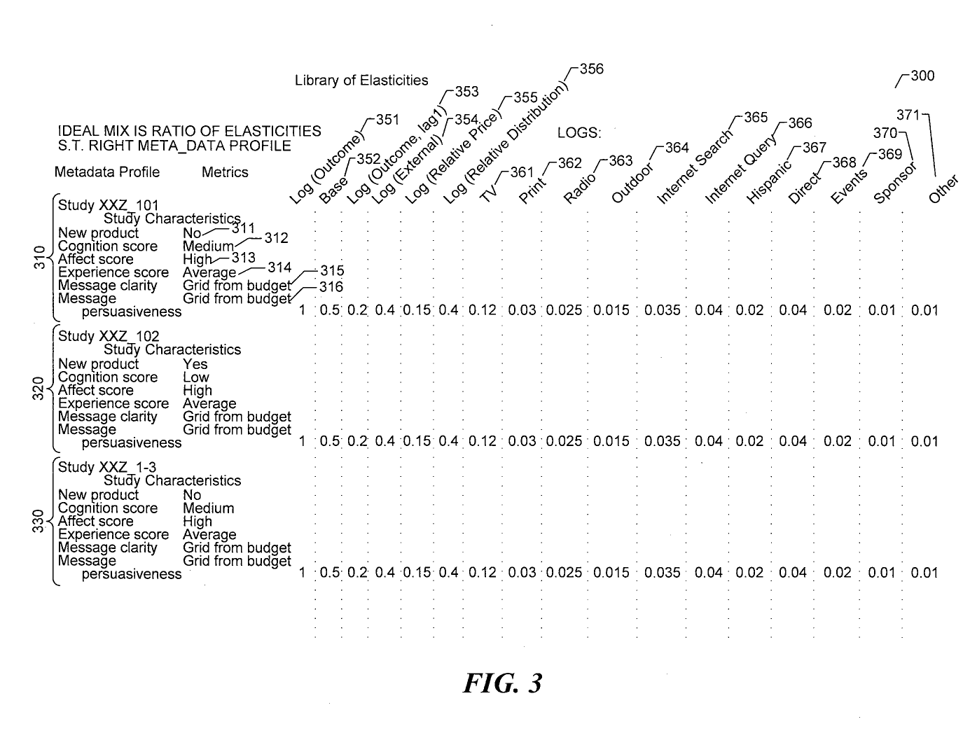

FIG. 3 is a table drawing showing sample contents of a library of historical marketing efforts. The library 300 is made up of entries, such as entries 310, 320, and 330, each corresponding to a set of one or more historical marketing efforts each sharing a similar context. Each entry contains a number of context attribute values that hold true for the historical marketing efforts corresponding to the entry, including values for a new product attribute 311, a cognition score attribute 312, an affect score attribute 313, an experience score 314, a message clarity score 315, and a message persuasiveness score 316. Each entry further contains values for the following statistical measures for the historical marketing efforts corresponding to the entry: log of the outcome 351, base 352, log of outcome with a lag factor 353, log of external 354, log of relative price 355, and log of relative distribution 356. Each entry further contains logs of advertising efficiency values for each of a number of categories, including TV 361, print 362, radio 363, outdoor 364, Internet search 365, Internet query 366, Hispanic 367, direct 368, events 369, sponsorship 370, and other 371.

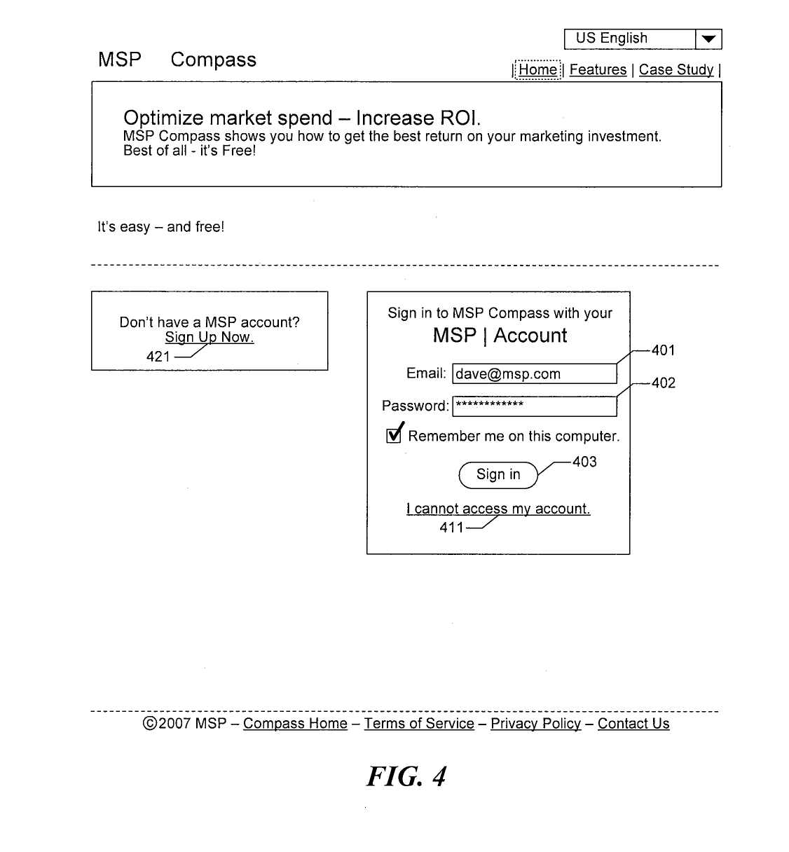

FIG. 4 is a display diagram showing a sign-in page used by the facility to limit access to the facility to authorized users. A user enters his or her email address into field 401, his or her password into field 402, and selects a signing control 403. If the user has trouble signing in in this manner, the user selects control 411. If the user does not yet have an account, the user selects control 421 in order to create a new account.

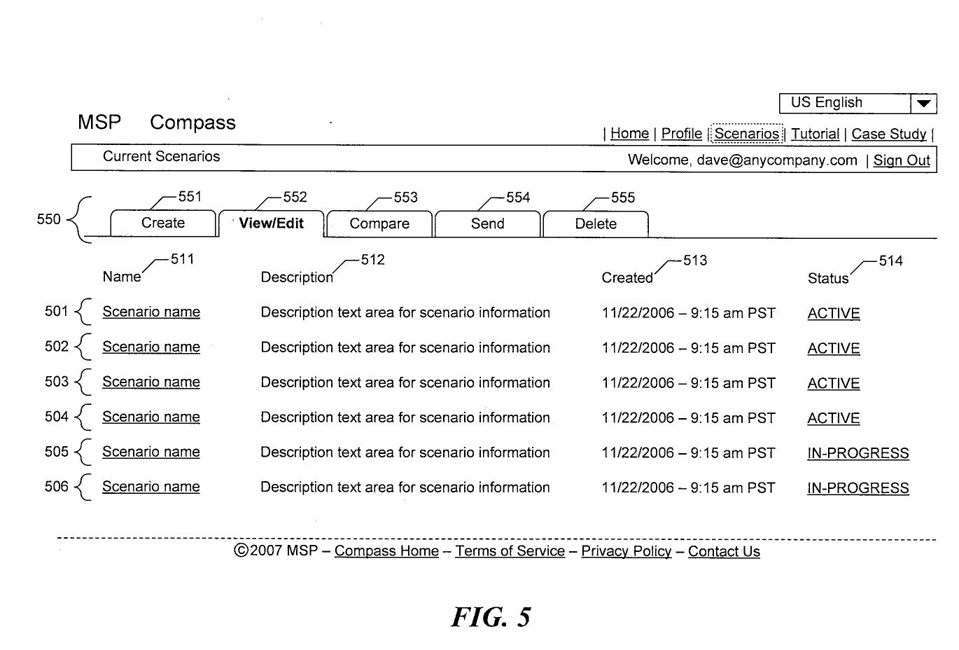

FIG. 5 is a flow diagram showing a page display generated by the facility in a view/edit mode. The display lists a number of scenarios 501-506, each corresponding to an existing offering prescription generated for the user, or generated for an organization with which the user is associated. For each scenario, the display includes the name of the scenario 511, a description of the scenario 512, a date 513 on which the scenario was created, and a status of the scenario. The user may select any of the scenarios, such as by selecting its name, or its status, to obtain more information about the scenario. The display also includes a tab area 550 that the user may use in order to navigate different modes of the facility. In addition to tab 552 for the present view/edit mode, the tab area includes a tab 551 for a create mode, a tab 553 for a compare mode, a tab 554 for a send mode, and a tab 555 for a delete mode. The user can select any of these tabs in order to activate the corresponding mode.

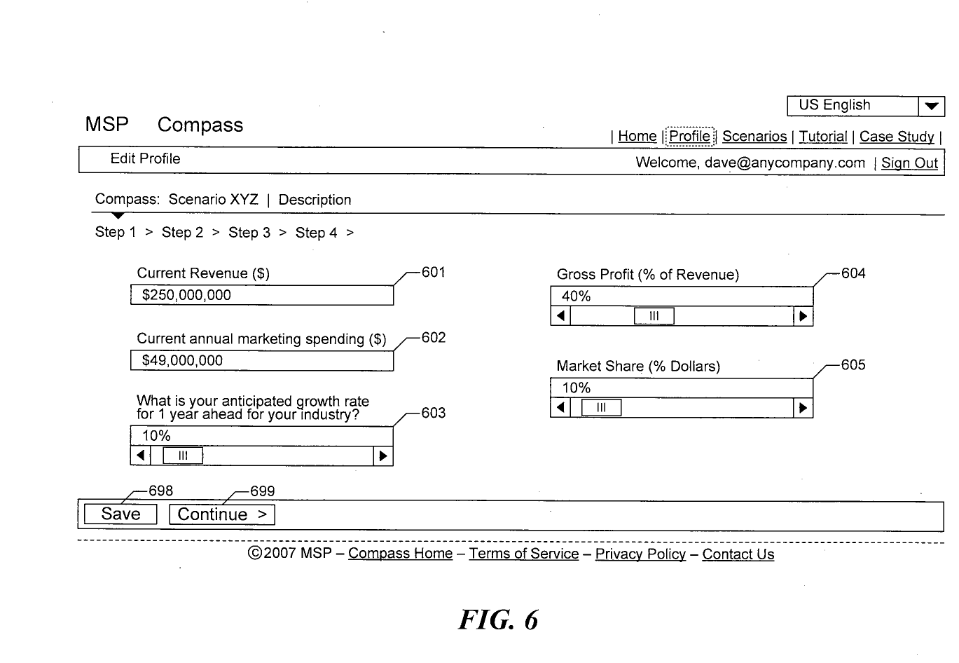

FIGS. 6-9 show displays presented by the facility in order to solicit information about the subject offering for which an overall marketing budget and its distribution are to be prescribed by the facility. FIG. 6 shows controls for entering values for the following attributes: current revenue 601, current annual marketing spending 602, anticipated growth rate for the next year in the industry as a whole 603, gross profit expressed as a percentage of revenue 604, and market share expressed as a percentage of dollar 605. The display further includes a save control 698 that the user can select in order to save the attribute values that they have entered, and a continue control 699 that the user may select in order to proceed to the next display for entering the context attribute values.

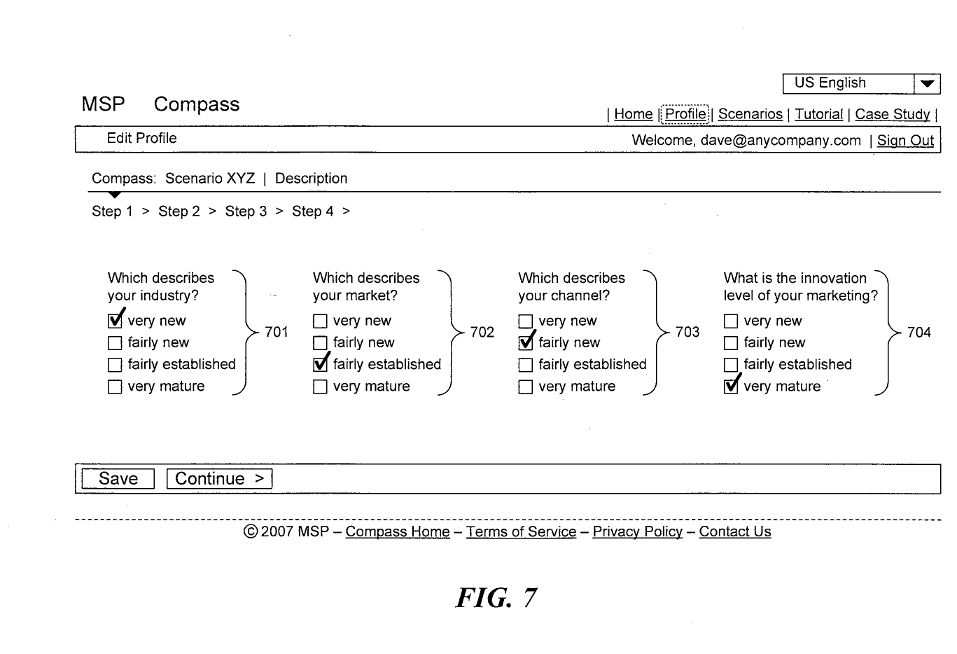

FIG. 7 is a further display presented by the facility to solicit attribute values for the subject offering. It includes controls for inputting values for the following context attributes: industry newness 701, market newness 702, channel newness 703, and marketing innovation 704.

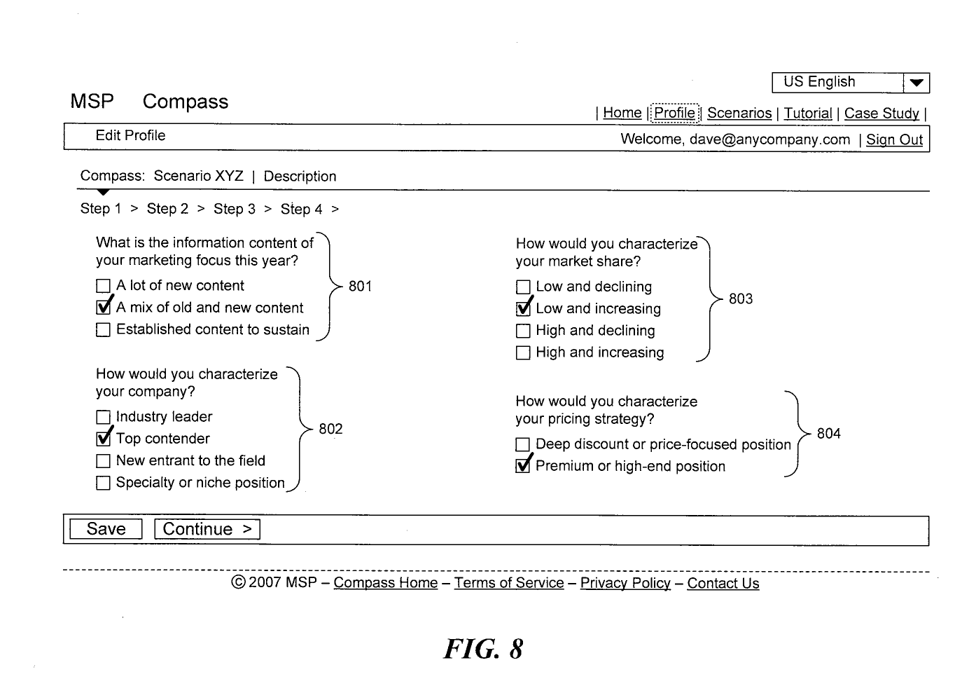

FIG. 8 is a further display presented by the facility in order to solicit attribute values. It has controls that the user may use to enter the values for the following context attributes: newness of marketing information content 801, company position in the market 802, market share 803, and pricing strategy 804.

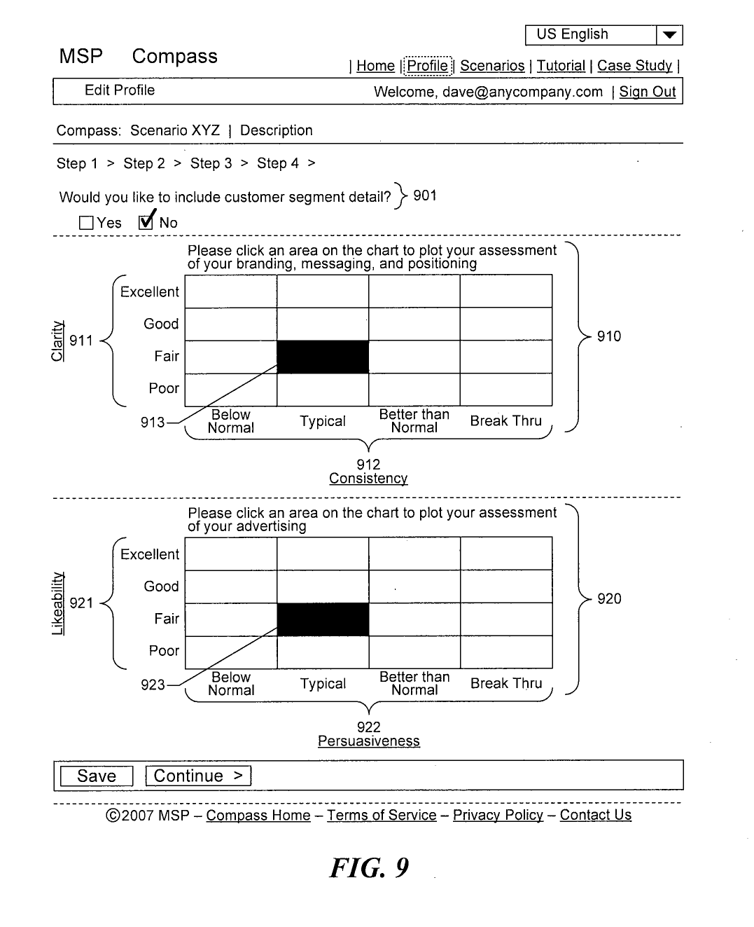

FIG. 9 is a further display presented by the facility in order to solicit attribute values. It contains a control 901 that the user may use to determine whether customer segment detail will be included. The display further contains charts 910 and 920 for specifying values of additional context attributes. Chart 910 can be used by the user to simultaneously specify values for the consistency and clarity of branding messaging and positioning efforts by the company responsible for the subject offering. In order to use chart 910, the user selects a single cell in the grid included in the chart corresponding to appropriate values of both the consistency and clarity attributes. Section 920 is similar, enabling the user to simultaneously select appropriate values for the persuasiveness and likeability of the company's advertising.

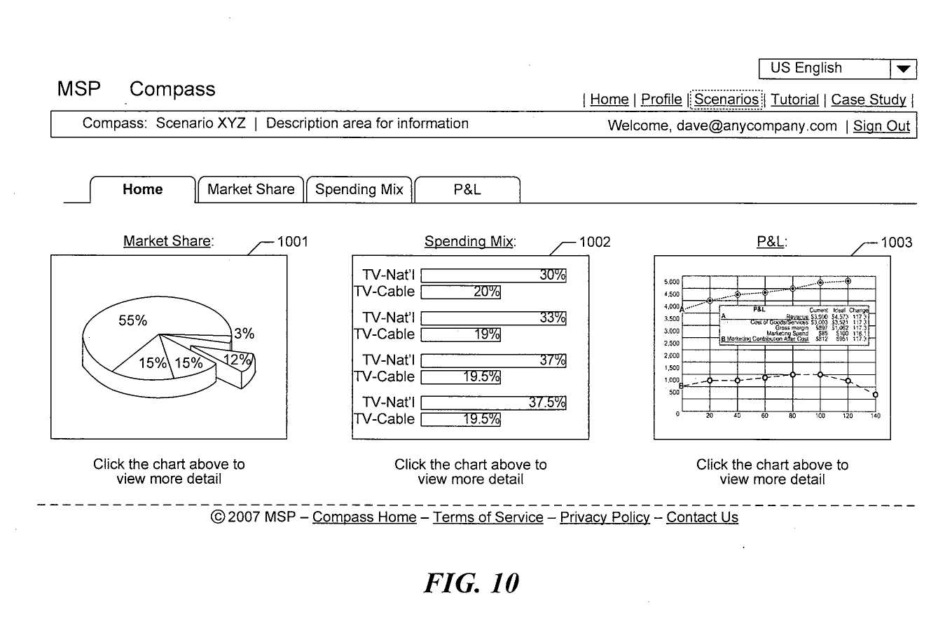

FIG. 10 is a display diagram showing a result navigation display presented by the facility after collecting information about the subject offering to permit the user to select a form of analysis for reviewing results. The display includes a control 1001 that the user may select in order to review market share information relating to the result, a control 1002 that the user may select in order to review spending mix information relating to the result, and a control 1003 that the user may select in order to review profit and loss information relating to the result.

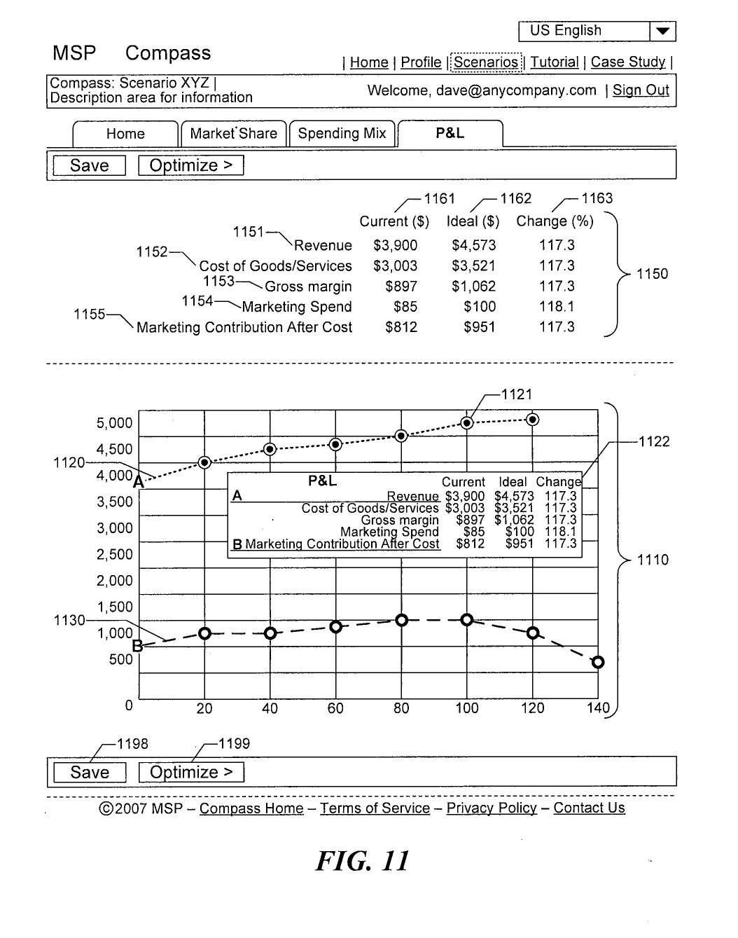

FIG. 11 is a display diagram showing a display presented by the facility to convey the optimal total marketing budget that the facility has determined for the subject offering. The display includes a graph 1110 showing two curves: revenue with respect to total marketing budget (or “marketing spend”) 1120 and profit (i.e., “marketing contribution after cost”) with respect to total marketing budget 1130. The facility has identified point 1131 as the peak of the profit curve 1130 and has therefore identified the corresponding level of marketing spend, $100, as the optimal marketing spend. The height of point 1131 shows the expected level of profit that would be produced by this marketing spend, and the height of point 1121 shows the expected level of total revenue that would be expected at this marketing spend. Table 1150 provides additional information about the optimal marketing spend and its calculation. The table shows, for each of current marketing spend 1161, ideal marketing spend 1162, and delta between these two 1163: revenue 1151 projected for this level of marketing spend; costs of goods and services 1152 anticipated to be incurred at this level of marketing spend; gross margin 1153 to be procured at this level of marketing spend; the marketing spend 1154; and the marketing contribution after cost 1155 expected at this level of marketing spend.

In order to define the profit curve and identify the total marketing budget level at which it reaches its peak, the facility first determines a total marketing budget elasticity appropriate for the subject offering. This elasticity value falls in a range between 0.01 and 0.30, and is overridden to remain within this range. The facility calculates the elasticity by adjusting an initial elasticity value, such as 0.10 or 0.11, in accordance with a number of adjustment factors each tied to a particular attribute value for the subject offering. Sample values for these adjustment factors are shown below in Table 1.

TABLE 1

| | Industry | Marketing | New | Market | Advertising |
|---|---|---|---|---|---|
| | Newness | Innovation | Information | Share | Quality |
| High | .05 | .1 | .05 | −.03 | .04 |
| Medium | 0 | 0 | 0 | 0 | 0 |
| Low | −.02 | −.03 | −.02 | .02 | −.03 |

The industry newness column corresponds to control 701 shown in FIG. 7. For example, if the top check box in control 701 is checked, then the facility selects the adjustment factor 0.05 from the industry newness column; if either of the middle two boxes in control 701 are checked, then the facility selects the adjustment factor 0 from the industry newness column; and if the bottom checkbox in control 701 is checked, then the facility selects the adjustment factor −0.02 from the industry newness column. Similarly, the marketing innovation column corresponds to control 704 shown in FIG. 7, the new information column corresponds to control 801 shown in FIG. 8, and the market share column corresponds to control 803 shown in FIG. 8. The advertising quality column corresponds to charts 910 and 920 shown in FIG. 9. In particular, the sum of the positions of the cells selected in the two graphs relative to the lower left-hand corner of each graph is used to determine a high, medium, or low level of advertising quality.

The facility then uses the adjusted total marketing budget elasticity to determine the level of total marketing budget at which the maximum profit occurs, as is discussed in detail below in Table 2.

TABLE 2
Definitions:
Sales = S
Base = β
Marketing Spend = M
Elasticity = α
Cost of Goods Sold (COGS) = C
Profit = P (P is a function of S, C, M, as defined in equation 2 below)
Fundamental equation relating Sales to Marketing (alpha and beta will be
supplied):
Equation (1): S = β*M^{α}
Equation relating Sales to Profits (C will be known); the facility substitutes
for Sales in equation (1) above and sets the program to maximize profits
for a given alpha and beta:
Equation (2): P = [S*(1 − C) − M]
$Solve Equation ( 2 ) for Sales \text{:} \frac{( P + M )}{( 1 - C )} = S$
$Substitute for S in Fundamental Equation \text{:} \frac{( P + M )}{( 1 - C )} = P * {M}^{α}$
Solve for P as a function of M, C, alpha and beta to obtain P as a function
of M:
P = [β*M^{α} *(1 − C)] − M
$Take derivatives \text{:} \frac{dP}{dM} = ( [ ( 1 - C ) βα ] * {M}^{α - 1} ) - 1$
Set to zero to give local inflection point: 1 = [(1 − C)βα]*M^{α-1}
$Solve for M \text{:} M = {( \frac{1}{[ ( 1 - C ) βα ]} )}^{\frac{1}{α - 1}}$
Check sign of second derivative (to see that it is a max not a min):
[(1 − C)βα(α − 1)]*M^{α-2} < 0 ?

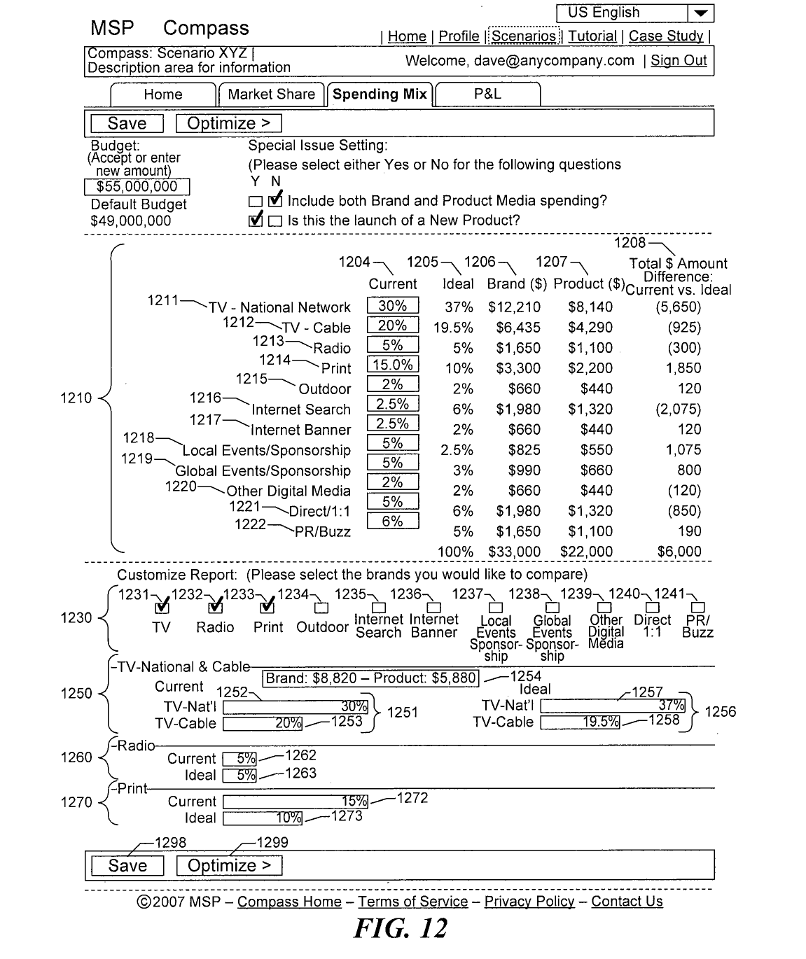

FIG. 12 is a display presented by the facility to show spending mix information. The display includes an overall budget 1201 prescribed by the facility. The user may edit this budget if desired to see the effect on distribution information shown below. The display also includes controls 1202 and 1203 that the user may use to identify special issues relating to the prescription of the marketing budget. The display further includes a table 1210 showing various information for each of a number of marketing activities. Each row 1211-1222 identifies a different marketing activity. Each row is further divided into the following columns: current percentage allocation 1204, ideal percentage allocation 1205, dollar allocation to brand in thousands 1206, dollar allocation to product in thousands 1207, and dollar difference in thousands between current and ideal. For example, from row 1214, it can be seen that the facility is prescribing a reduction in allocation for print advertising from 15% to 10%, $3.3 million of which would be spent on print advertising for the brand and $2.2 million of which would be spent on print advertising for the product, and that the current allocation to print marketing is $1.85 million greater than the ideal allocation. The display further includes a section 1230 that the user may use to customize a bar chart report to include or exclude any of the budget and marketing activities. It can be seen that the user has selected check boxes 1231-1233, causing sections 1250, 1260, and 1270 to be added to the report containing bar graphs for the TV, radio, and print marketing activities. In section 1250 for the TV marketing activity contains bar 1252 for the current percentage allocation to national TV, bar 1253 for the current percentage allocation to cable TV, bar 1257 for the ideal percentage allocation to national TV, and bar 1258 for the ideal percentage allocation for cable TV. The other report sections are similar.

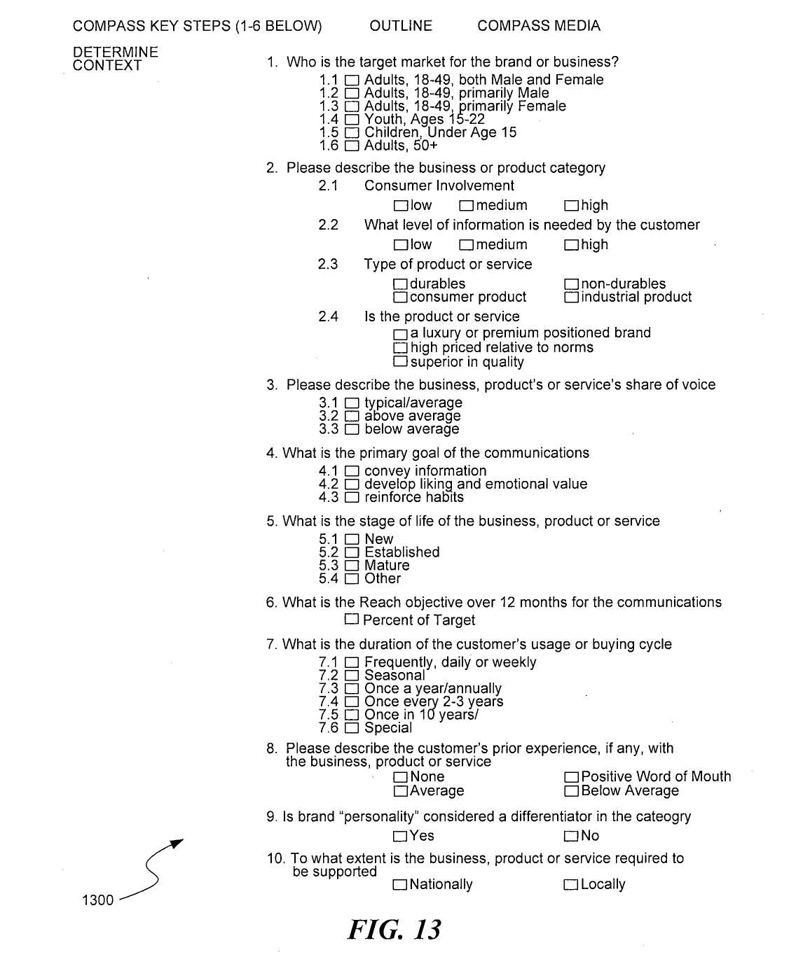

FIGS. 13-18 describe the process by which the facility determines the activity distribution shown in FIG. 12. FIG. 13 is a process diagram that describes collecting additional offering attribute information from the user. In some embodiments, this additional attribute information is obtained from the user using a user interface that is similar in design to that shown in FIGS. 6-9. FIG. 13 shows a number of attributes 1300 for which values are solicited from the user for the subject offering.

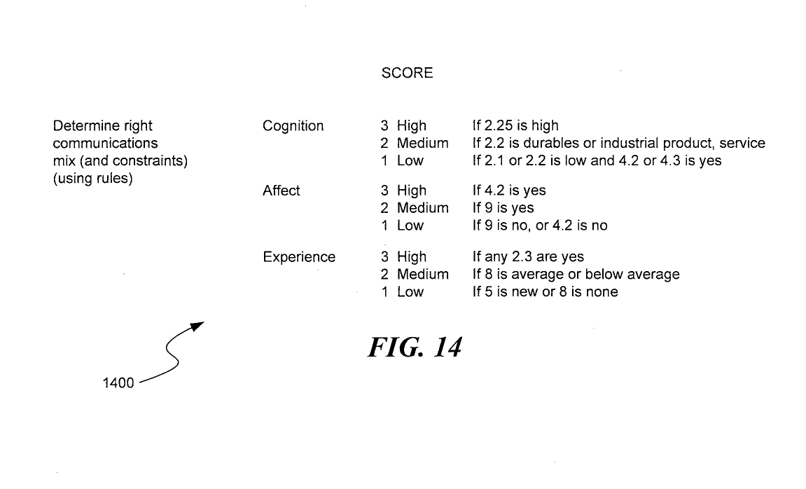

FIG. 14 is a process diagram showing the derivation of three derived measures for the subject offering: cognition, affect, and experience. The values for these derived measures are derived based upon the value of attributes shown in FIG. 13 provided by the user for the subject offering.

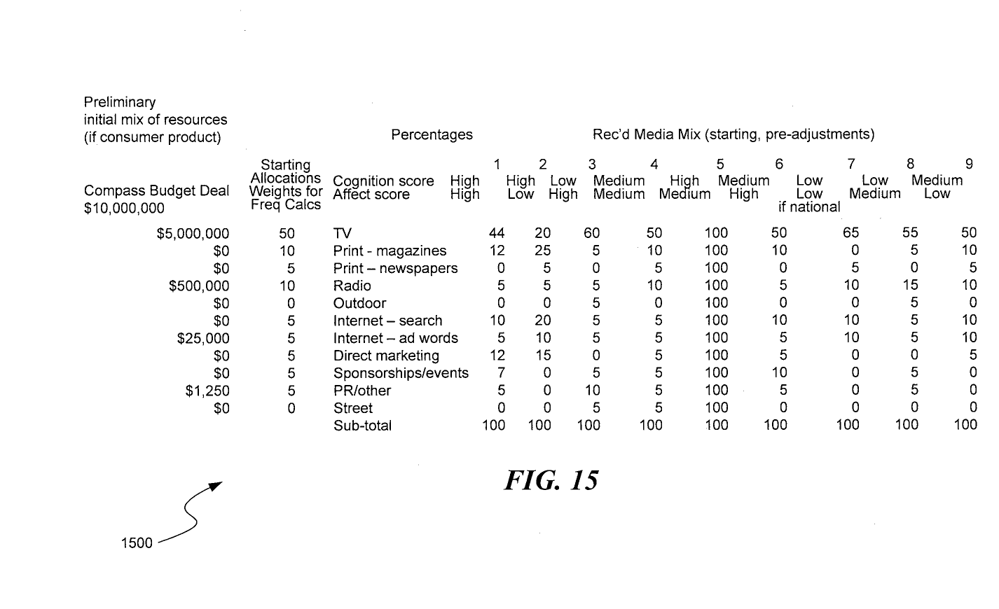

FIG. 15 is a table diagram showing sets of marketing activity allocations, each for a different combination of the three derived attributes shown in FIG. 14. For example, FIG. 15 indicates that, for subject offerings assigned a high cognition score and medium affects score should be assigned marketing resources in the following percentages: TV 44%, print magazines 12%, print newspapers 0%, radio 5%, outdoor 0%, internet search 10%, internet ad words 5%, direct marketing 12%, sponsorships/events 7%, PR/other 5%, and street 0%. Each of these nine groups of allocations is based on the relative activity elasticities, like those shown in FIG. 3, grouped by the cognition and affect scores indicated for the groups of historical marketing efforts contained in the library.

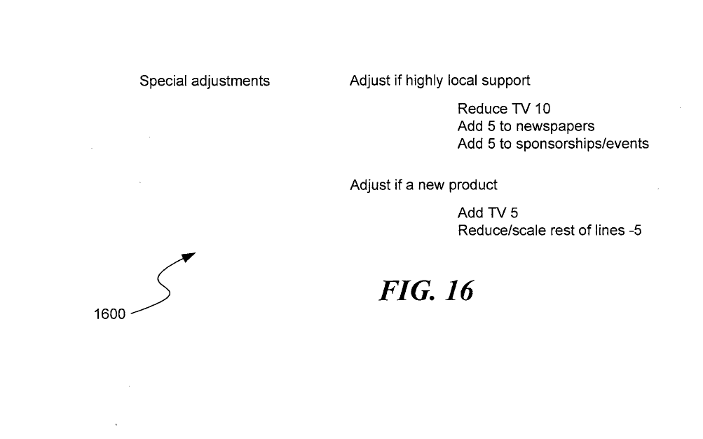

FIG. 16 is a process diagram showing how the initial allocation specified by the table in FIG. 15 should be adjusted for a number of special conditions 1600.

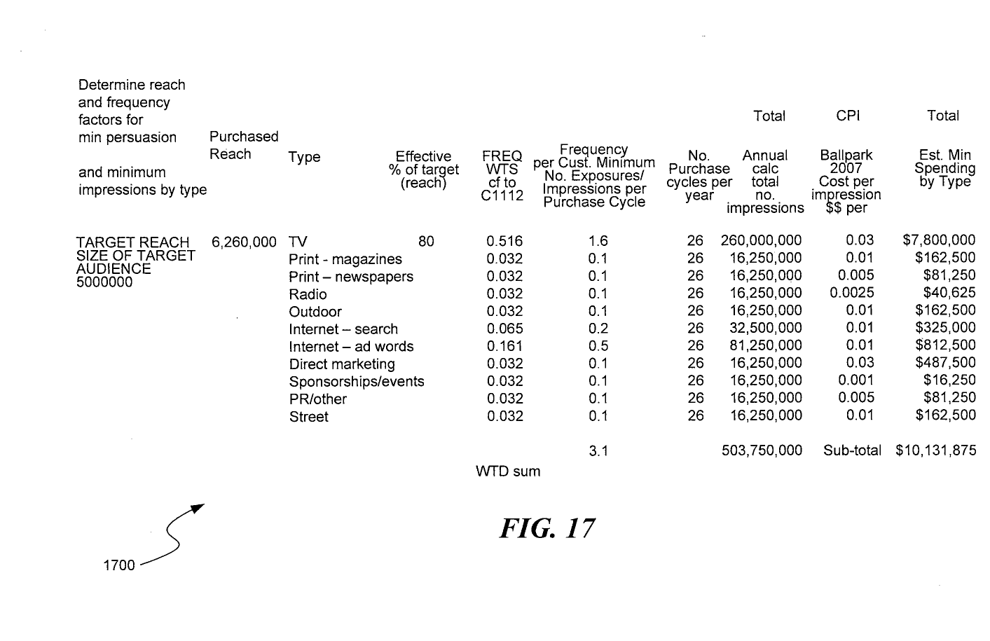

FIG. 17 is a process diagram showing how the facility determines dollar amount for spending on each marketing activity. The process 1700 takes the size of target audience specified by the user and divides by affective percentage of target to obtain a purchased reach—that is, the number of users to whom marketing messages will be presented. This number is multiplied by the adjusted allocation percentage to obtain a frequency per customer which is then multiplied by a number of purchase cycles per year and cost per impression to obtain estimated spending for each activity.

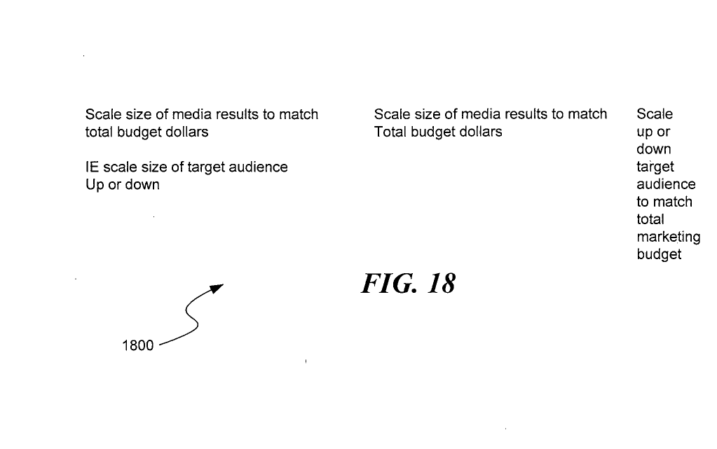

FIG. 18 is a process diagram showing the final adjustment to the results shown in FIG. 17. Process 1800 specifies scaling the target audience up or down to match the total marketing budget determined by the facility for the subject offering.

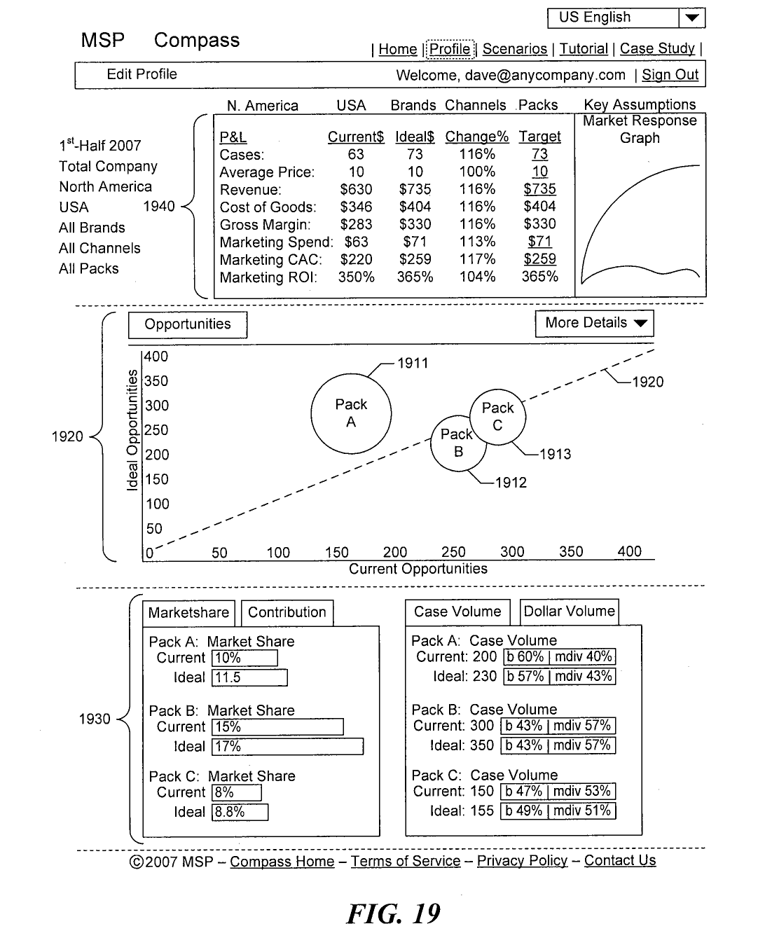

FIG. 19 is a display diagram showing a display presented by the facility to portray resource allocation prescriptions made by the facility with respect to a number of related subject offerings, such as the same product packaged in three different forms. The display includes a chart 1910 that graphically depicts each of the related subject offerings, pack A, pack B, and pack C, each with a circle. The position of the center of the circle indicates the current and ideal total marketing budget allocated to the offering, such that each circle's distance and direction from a 45° line 1920 indicates whether marketing spending should be increased or decreased for the offering and by how much. For example, the fact that the circle 1911 for pack A is above and to the left of the 45° line indicates that marketing spending should be increased for pack A. Further, the diameter and/or area of each circle reflects the total profit attributable to the corresponding subject offering assuming that the ideal total marketing budget specified by the facility for that offering is adopted. The display also includes a section 1930 containing a bar graph showing market share and volume, both current and ideal, for each related subject offering. The display also includes a section 1940 showing information similar to that shown in Section 1150 of FIG. 11.

It will be appreciated by those skilled in the art that the above-described facility may be straightforwardly adapted or extended in various ways. While the foregoing description makes reference to particular embodiments, the scope of the invention is defined solely by the claims that follow and the elements explicitly recited therein.

We claim:

1. A method in a computing system for automatically prescribing an allocation of resources to a total marketing budget for a distinguished offering, with the goal of optimizing a distinguished business outcome for the offering that is expected to be driven at least in part by the allocation of resources to the total marketing budget, comprising:
receiving qualitative attributes of the distinguished offering from a user;
retrieving an experimentally-obtained average total marketing budget lift factor;
adjusting the experimentally-obtained average total marketing budget lift factor based upon at least two of the received qualitative attributes of the distinguished offering; and
using the adjusted experimentally-obtained average total marketing budget lift factor to determine an allocation of resources to a total marketing budget that tends to optimize the distinguished business outcome.

2. The method of claim 1, further comprising persistently storing the determined allocation of resources.

3. The method of claim 1, further comprising displaying the determined allocation of resources to a user.

4. The method of claim 1 wherein the retrieved experimentally-obtained average total marketing budget lift factor is an experimentally-obtained average total marketing budget elasticity measure.

5. A computer-readable medium whose contents cause a computing system to perform a method for automatically prescribing an allocation of resources to a total marketing budget for a distinguished offering, with the goal of optimizing a distinguished business outcome for the offering that is expected to be driven at least in part by the allocation of resources to the total marketing budget, comprising:
receiving qualitative attributes of the distinguished offering from a user;
retrieving an experimentally-obtained average total marketing budget lift factor;
adjusting the experimentally-obtained average total marketing budget lift factor based upon at least two of the received qualitative attributes of the distinguished offering; and
using the adjusted experimentally-obtained average total marketing budget lift factor to determine an allocation of resources to a total marketing budget that tends to optimize the distinguished business outcome.

6. A method in a computing system for automatically prescribing an allocation of resources to each of one or more activities to be performed with respect to a distinguished offering, with the goal of optimizing a business outcome for the offering that is expected to be driven at least in part by the activities, comprising:
receiving information from a user characterizing attributes of the distinguished offering;
for each of the activities, determining a lift factor derived from experimental results for one or more offerings that, while distinct from the distinguished offerings, are determined to be similar to the distinguished offerings based on the received information characterizing attributes of the distinguished offering, the lift factor indicating the predicted effect of the activity on the business outcome; and
using the retrieved lift factors to generate an allocation of resources for each of the activities.

7. The method of claim 6 wherein the determining comprises:
using the received information characterizing a first portion of the attributes of the distinguished offering to select a lift factor corresponding to experimental results for offerings whose first portion of attributes are characterized in a similar way; and
adjusting the selected lift factor based on using the received information characterizing a second portion of the attributes of the distinguished offering.

8. The method of claim 6, further comprising automatically committing resources to at least one of the activities in accordance with the allocation generated for those activities.

9. A computer-readable medium whose contents cause a computing system to perform a method for automatically prescribing an allocation of resources to each of one or more activities to be performed with respect to a distinguished offering, with the goal of optimizing a business outcome for the offering that is expected to be driven at least in part by the activities, the method comprising:
receiving information from a user characterizing attributes of the distinguished offering;
for each of the activities, determining a lift factor derived from experimental results for one or more offerings that, while distinct from the distinguished offerings, are determined to be similar to the distinguished offerings based on the received information characterizing attributes of the distinguished offering, the lift factor indicating the predicted effect of the activity on the business outcome; and
using the retrieved elasticity measures to generate an allocation of resources for each of the activities.

10. The computer-readable medium of claim 9 wherein the determining comprises:
using the received information characterizing a first portion of the attributes of the distinguished offering to select a lift factor corresponding to experimental results for offerings whose first portion of attributes are characterized in a similar way; and
adjusting the selected lift factor based on using the received information characterizing a second portion of the attributes of the distinguished offering.

11. The computer-readable medium of claim 9 further comprising automatically committing resources to at least one of the activities in accordance with the allocation generated for those activities.

12. One or more computer memories collectively storing a generalized marketing lift factor data structure, comprising a plurality of entries each for a different business offering profile, each business offering profile describing a group of one or more business offerings that are qualitatively distinguished from groups of business offerings of the other business offering profile, each entry containing a lift factor indicating the effect of a marketing activity with respect to the group of business offerings on a business outcome,
such that, for a distinguished business offering described by a distinguished one of the profiles, the lift factor indicated by the distinguished entry may be used to automatically specify an allocation of marketing resources to the distinguished business offering.

13. The computer memories of claim 12 wherein the lift factor contained by each entry is an elasticity measure.
